(19) United States
(12) Patent Application Publication
(10) Pub. No.: US 2005/0224269 A1
(43) Pub. Date: Oct. 13, 2005

(54) Vehicle operator's platform

(75) Inventor: Peter Dahl, Gaiberg (DE)

Correspondence Address: Joel S. Carter;Patent Department, DEERE & COMPANY, One John Deere Place, Moline, IL, 61265-8098, US

(73) Assignee: Deere & Company, a Delaware corporation

(21) Appl. No.: 11/077,850

(22) Filed: Mar. 11, 2005

(30) Foreign Application Priority Data
Apr. 7, 2004 (DE) 10 2004 017 118.1

(51) Int. Cl. B60R 21/13

(52) U.S. Cl. 180/89.12; 280/756

(57) ABSTRACT

An open adaptable operator's platform is provided for a vehicle, such as an agricultural or industrial utility vehicle. The platform is movably supported on the vehicle in order to damp and/or suppress vibrations during operation. Rollover protection is fastened to the platform to protect an operator at least partially from injury in case the vehicle is overturned. Noise generated by the rollover protection is reduced or avoided.

### BACKGROUND

The present invention relates to an operator platform for a vehicle, such as an agricultural or industrial utility vehicle.

Lower power and lower price tractors are provided with open platforms, where an “open platform” is a platform which does not include a complete cab with cab posts, cab roof and a corresponding glazed enclosure.

Such platforms have been either fastened rigidly to the vehicle, or supported on springs on the vehicle. Spring supported platforms result in increased comfort, since shocks or vibrations of the vehicle can largely be suppressed during operation.

However, vehicles with an open platform must be equipped with a rollover protection, which protects an operator on that platform against injury and in particular against the danger that the operator is trapped under the vehicle or crushed in the case of a rollover or overturning of the vehicle.

Rollover protection has been fastened rigidly to the vehicle or has been fastened to the platform which was rigidly fastened to the vehicle. As a result, vehicle operation produced noise, particularly high frequency noise, which was radiated by the rollover protection, because the rollover protection was located in the immediate proximity of the ears of the operator. It is known to reduce vibrations or oscillations of the rollover protection with a certain frequency with vibration control springs, but only for a narrow frequency range. Such springs are costly, increase vehicle weight, and cannot reduce noise in a broad-band of vibration frequencies.

### SUMMARY

Accordingly, an object of this invention is to provide an operator platform which reduces or eliminates noise generated by the rollover protection.

These and other objects are achieved by the present invention, wherein a rollover protection is fastened to a platform in order to minimized or even eliminate noise. Since the platform is supported so as to move relative to the vehicle, the vibrations generated by vehicle operation are no longer transmitted to the platform or transmitted only partially. Correspondingly, the rollover protection is no longer subjected to the vibrations or oscillations of the vehicle, but, if at all, then only to the degree that vibrations or oscillations of the vehicle are transmitted to the platform. This improves operator comfort and provides a very considerable noise reduction. The use of known vibration dampers, that could be attached to the rollover protection, can largely be omitted or in case such dampers are nevertheless provided, they can be reduced to smaller dimensions. This results in cost reduction.

The rollover protection may be configured generally in a U-shaped, bar-shaped or bow-shaped arrangement. Preferably, the rollover protection is in the form of a roll-bar, as is known in the art.

The rollover protection may include at least two posts and a connecting part. Each of the posts may be arranged on a side of the platform and extend generally upward vertically. The posts extend preferably above the height of the head of an operator located on the platform. Preferably, the posts extend beyond the height of the head of an operator, on the basis of a statistical body size, by at least 30 to 50 cm. The connecting part extends between the two posts, preferably in an upper region or the end region of the posts.

Preferably the posts are generally arranged in a rear and/or forward region of the platform, where the designation “rear or forward” refers to the direction of operation of the vehicle. Two rollover protection devices could be provided, that is, for example, a rollover protection in the forward region and a further rollover protection in the rear region of the platform.

Preferably the rollover protection has a profile with a rectangular or a round cross section and is preferably manufactured from metal, such as steel. The rollover protection could be welded or bolted to the platform. By welding the rollover protection to the platform manufacturing costs could be reduced by eliminating fasteners such as screws.

Preferably, the platform together with the rollover protection have a sufficiently high stiffness so that they resist significant deformation if the vehicle is overturned. Accordingly, the platform and rollover protection must be dimensioned so that at least the simple weight of the vehicle cannot deform the platform and the rollover protection or do so only to an insignificant degree. For this purpose, the possible kinetic energy that the vehicle could develop together with any trailers coupled to the vehicle or other attached implements must be considered.

The platform may be provided with at least a sheet metal support or a strut arranged at the side and/or vertically on the platform in order to prevent any deformation of the platform and the rollover protection in the case of an overturning of the vehicle.

Preferably, the rollover protection is provided with a folding arrangement, with which the upper part of the rollover protection can be folded to the front or to the rear, so that the tractor can also operate, for example, under bridges with low clearance.

The platform may be movably supported relative to the platform by a rubber, spring, air or fluid support device. The support could be a passive platform spring support device such as rubber padding. Alternatively, the support may be an active spring support with spring or damping characteristics conformed to the operating conditions of the vehicle. This could be performed by hydraulic or pneumatic systems.

Preferably, the platform includes an operator's seat which may be supported on springs relative to the platform. Moreover, the platform could be provided with vehicle operating elements, such as a steering wheel, a clutch pedal, a gas pedal, a brake pedal and/or at least a gear shift.

### BRIEF DESCRIPTION OF THE DRAWINGS

FIG. 1 is a schematic side view of an embodiment according to the present invention;

FIG. 2 is a schematic rear view of an embodiment according to the present invention.

### DETAILED DESCRIPTION

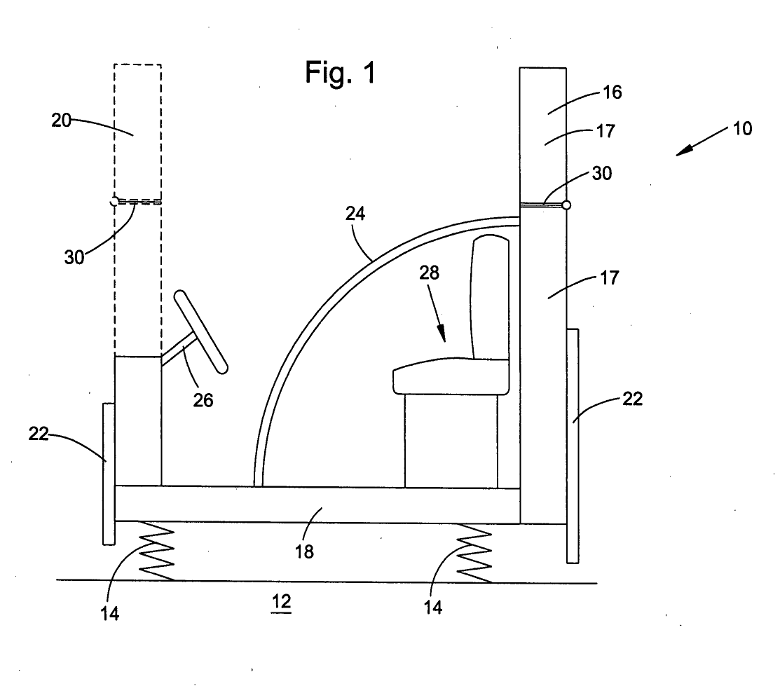

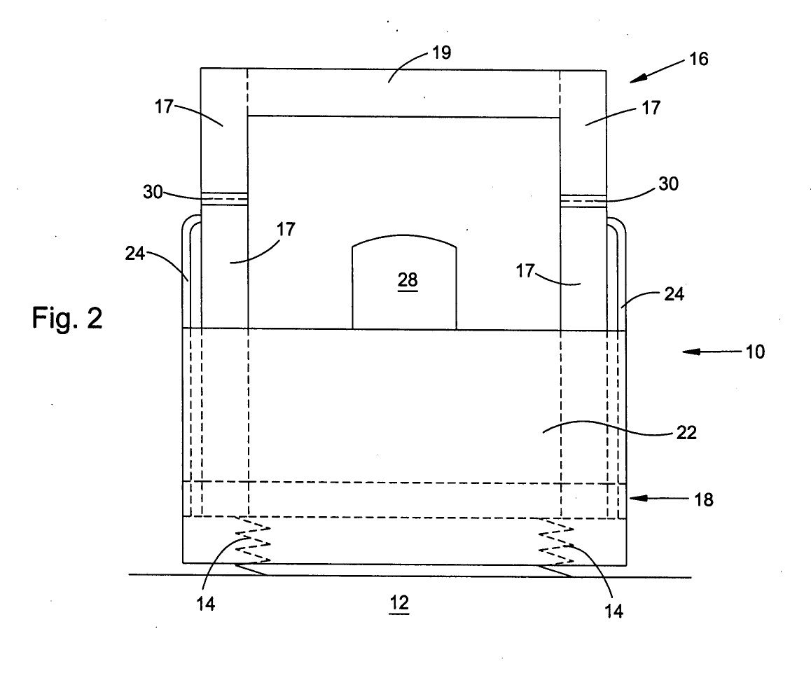

FIGS. 1 and 2 show an open platform 10 that is arranged on a vehicle of which only the chassis 12 is shown. The platform 10 is an open platform and has no enclosed cab. The platform 10 is supported on the chassis 12 by spring support elements 14 so that platform 10 is movable relative to the chassis 12. The support elements 14 are definitely rubber bolsters (not shown) through which pins (not shown) extend which connect the platform 10 with the chassis 12, so that the platform is moveable relative to the chassis 12, at least in the vertical direction.

A rollover protection 16 is fastened to a floor 18 of the platform 10. As best seen in FIG. 2, the rollover protection 16 is configured in the form of a bar. The rollover protection 16 includes two posts 17, that extend generally in the vertical direction from the platform floor 18 and which are connected at their upper ends by a connecting part 19. The posts 17 of the rollover protection 16, however, could extend upward at an angle to the vertical from the platform floor. The rollover protection 16 is positioned in the rear region of the platform 10 relative to the principal operating direction of the vehicle. Alternatively or in addition, the rollover protection 16 could also be arranged in the forward region of the platform 10, as is indicated by dashed lines 20 of FIG. 1.

The platform 10 is also provided with sheet metal supports 22 which prevent deformations of the platform 10 and the rollover protection 16. These supports 22 are arranged in the forward and the rear region of the platform 10. Moreover a strut or hand rail 24 on each side of the platform 10 connects the rollover protection 16 with the platform floor 18 and adds stiffness or rigidity to the platform 10.

A steering wheel 26 and an operator's seat 28 are arranged on the platform 10. A folding device 30 permits the upper part of the rollover protection 16 to be folded down, in case the vehicle is required to operate under a low bridge.

The result is an open operator platform which can be adapted to a vehicle, which can move relative to the vehicle in order to dampen and/or suppress shocks during the operation of the vehicle, and which includes rollover protection to protect the operator against injury at least partially in the case the vehicle is overturned.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

### Assignment

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. An open operator's platform for a utility vehicle, the platform being movably supported relative to a chassis of the vehicle by vibration damping supports, the improvement wherein:
rollover protection is fastened to the platform.

2. The platform of claim 1, wherein:
the rollover protection includes a roll-bar.

3. The platform of claim 1, wherein:
the rollover protection includes a pair of posts and a connecting part, each of the posts being arranged on one side of the platform and extending generally upward vertically, and the connecting part extends between upper ends of the posts.

4. The platform of claim 3, wherein:
the posts are arranged in a rear region of the platform.

5. The platform of claim 3, wherein:
the posts are arranged in a forward region of the platform.

6. The platform of claim 1, wherein:
the rollover protection is welded or bolted to the platform.

7. The platform of claim 1, wherein:
the platform and the rollover protection are sufficiently stiff so that in the case of an overturning almost no deformation of the platform and the rollover protection occurs.

8. The platform of claim 1, wherein:
the platform includes a stiffener which prevents deformation of the platform and the rollover protection in the case of an overturning.

9. The platform of claim 8, wherein:
the stiffener comprises a sheet metal support mounted on a side of the platform.

10. The platform of claim 8, wherein:
the stiffener comprises a strut mounted on a side of the platform.

11. The platform of claim 1, wherein:
the rollover protection includes a folding device which permits a portion of the rollover protection to be folded down.

12. The platform of claim 1, further comprising:
resilient supports for supporting the platform movably relative to the chassis.

13. The platform of claim 1, wherein:
the platform includes an operator's seat.

14. The platform of claim 1, wherein:
the platform includes at least one of a set of vehicle operating elements, including a steering wheel, a clutch pedal, a gas pedal, a brake pedal and a gear shift.
